(19) United States
(12) Patent Application Publication
(10) Pub. No.: US 2006/0073313 A1
(43) Pub. Date: Apr. 6, 2006

(54) Photo realistic paper for printing and copying images

(76) Inventor: Nabil F. Nasser, Dayton, OH (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 11/244,531

(22) Filed: Oct. 5, 2005

Related U.S. Application Data
(60) Provisional application No. 60/616,880, filed on Oct. 6, 2004.

(51) Int. Cl. B41M 5/00

(52) U.S. Cl. 428/195.1

(57) ABSTRACT

A photorealistic paper has a paper substrate with a polymer print side layer applied to the print side thereof, the polymer selected from the group including polyethylene, polypropylene, polyester and blends thereof. A receptor layer is applied over the polymer print side layer, the receptor layer may adapt to accept printing by ink-jet printers and by laser printers. A polymer layer is provided on the back side. In one embodiment, the paper substrate is 8-10 mils. The print side layer includes over 50% LDPE and has a glass transition temperature of 5-30° C. and the receptor layer is adapted for laser printing. In another embodiment, the print side layer is polyester, and the back side layer is perforated.

### RELATED APPLICATION

This application claims benefit to my prior U.S. Provisional Application Ser. No. 60/616,880 filed Oct. 6, 2004.

### FIELD OF INVENTION

The invention herein relates to photo realistic paper for reproducing images by ink-jet printing and by laser printing.

### BACKGROUND OF INVENTION

Digital photography has become widely accepted as an alternative to film photography, and the images of digital photography are printed using ink-jet printers and laser printers. The digital images may also be transmitted by the Internet or on disks, for printing by such means at other locations. Further, color copiers are in common usage, and photographs or other digital images can be reproduced using color copiers, or black and white copiers in some instances; however, the copier printing process is sufficiently similar to laser printing that it shall be considered included with laser printing for discussion herein.

Digital images can be printed on standard printer and copier papers, but printing on such papers does not produce a high quality image nor a substitute for a photograph. Standard printer and copier paper is simply not equivalent to the substrates used in conventional film processing and printing, but users want their printed digital photographs to have comparable quality to developed film photographs.

Specialty papers for printing digital images have been developed which attempt to produce a printed photograph of comparable quality to photographs produced by conventional film processing and printing. These specialty papers are sometimes referred to as photo realistic paper. In ink-jet printing, small droplets of ink are deposited on the surface of the paper, and are heat dried to fix the image. In laser printing, toner particles are deposited on the surface of the substrate, and are melted and dried by heat to form the image. The laser printing process subjects the paper to substantially higher temperatures than ink-jet printing.

The prior art photorealistic papers generally comprise a polyester sheet or a paper substrate with a polyester surface layer that is laminated or extruded onto the paper substrate. These papers have generally been provided in thicknesses of about 5 mils, and at a maximum thickness of about 6-7 mils, i.e. less than the thickness of a traditional photograph printed from a developed negative onto photographic paper. For this reason alone, the prior art photorealistic papers for printing images have been unsatisfactory.

However, the solution has not been to merely increase the thickness of the paper, due to difficulties in successful laser printing onto thicker papers with a polyester surface layer. These problems include both poor print quality and delamination of the paper. Therefore, there is a need for photorealistic papers that are thicker and that print well.

When one of the prior art thin polyester photorealistic papers is used for laser printing, a receptor layer specifically adapted to laser printing is top-coated over the polyester surface layer. Similarly, when the photorealistic paper is for use in ink-jet printing, a receptor layer specifically adapted to ink-jet printing is top-coated over the polyester layer. Therefore, photo realistic papers are presently provided in two classifications; namely, one for ink-jet printing and one for laser printing and copying. In general, it is not successful to use photo realistic paper designed for ink-jet printers in laser printers or copiers, and vice versa.

Accordingly, it would benefit users, and especially the casual user who does not want to keep separate supplies of paper, to have access to a photo realistic paper that performs well in ink-jet printers and also performs well in laser printers. It would also benefit users to have photorealistic paper of the thickness of traditional photographic prints and the capability of producing high quality images.

### SUMMARY OF THE INVENTION

It is a principal object of the invention herein to provide photo realistic papers.

It is also a principal object of the invention herein to provide a photo realistic papers for ink-jet printing and for laser printing.

It is another principal object of the invention to provide photorealistic paper of substantial thickness.

It is a further object of the invention herein to provide photorealistic papers that exhibit good longevity, and resist curling, cracking and water damage.

It is also an object of the invention herein to provide photorealistic papers that produce high quality printed pictures.

In carrying out the objects of the invention, a photo realistic paper is provided with a paper substrate, a layer of polyolefin, including polyethylene, polypropylene or blends thereof, applied to a print side of the paper substrate, and a receptor layer applied over the polyolefin, the receptor layer adapted to accept printing by ink-jet printers, by laser printers, or by both ink-jet printers and laser printers. The photo realistic paper may further generally comprise a polymer layer, including polyethylene, polypropylene, polyester, ethyl vinyl acetate, or blends hereof, applied to a back side of the paper substrate.

The paper substrate may be a high quality pulp and fiber paper having a thickness in the range of 3-14 mils and preferably 4-11 mils. The paper may or may not be clay coated on the print side and on the back side. Especially preferred papers have a weight of 180-200 g/m² and a thickness in the range of 8-10 mils.

The polyolefin layer applied to the print side is preferably low density polyethylene (LDPE), and may be a blend of LDPE and high density polyethylene (HDPE). The blend, if used, is preferably from about 50%-99% LDPE and 1-50% HDPE. The polymer has a glass transition temperature of between −19° C. and 60° C., and preferably between 5° C. and 30° C. Pigment, such as titanium dioxide (TiO₂), may be added to the polyolefin to brighten the print side, the pigment being added in a range from 0.1-20% of the polyolefin, with a preferred range of 7-15% of the polyolefin. Alternatively, pigment may be provided in a clay coating of the paper substrate. The polyolefin is extruded onto the paper substrate at a rate of 7-35 g/m², with a preferred application rate of 12-30 g/m² and a most preferred application rate of 20-25 g/m². An adhesion layer, generally having a polyurethane base, may be provided on the print side of the paper substrate, if required, for good adhesion of the polyolefin.

The receptor layer is applied over the polymer layer, at a rate of 4-50 g/m², and preferably at a rate of 6-25 g/m². The receptor layer may be applied in one, two or three coats to realize the total desired weight of application. The polyolefin may be Corona-treated to improve adhesion of the receptor layer, to a Dyne level of 35+. Satisfactory receptor layers may have a polyurethane base with dye fixatives and transparent pigments, e.g. aluminum silicate with a particle size of less than 300 nanometers.

The print side of the photo realistic paper is generally provided with a gloss or semi-gloss appearance, preferably with a reflectance in the range of 80-85% at an angle of 75°.

The back side of the photo realistic paper is also provided with an extruded layer of polymer, preferably 100% HDPE or a blend of about 50%-99% HDPE with the remainder of LDPE. Polypropylene, polyester and ethyl vinyl acetate are also suitable, provided a high glass transition temperature specification is maintained. Additives, such as pigmentation, anti-static material, and wax for lubrication purposes, may be added in the range of 0.1-5% of the polymer. The polymer is applied at a rate of 10-35 g/m², and preferably in the range of 22-30 g/m². An adhesion promoting primer may be used, as desired. The back surface of the photo realistic paper is generally provided in a matte or semi-matte finish, which may have a reflectance in the range of 10-25°. An acrylic or polyurethane anti-blocking surface coat may be provided, including polystyrene or equivalent particles in a size range of 5-35 microns, and preferably 7-28 microns, to improve separation of sheets and feeding to printers and copiers, as well as to provide additional heat absorption.

The invention also relates to photorealistic paper having a paper substrate, a polyester layer on a print side of the paper substrate, a receptor layer adapted for printing by both ink-jet printers and laser printers applied to the print side polyester layer, and a polymer layer on a back side of the paper substrate. When the paper substrate is about 9 mils or thicker, the receptor layer may be adapted for laster printing only, and the polymer layer on the back side of the paper substrate is perforated.

Other and more specific objects and features of the invention herein will, in part, appear in the following description of the preferred embodiment and the claims, taken together with the drawings.

### BRIEF DESCRIPTION OF DRAWINGS

FIG. 1 is a sectional view of a sheet of photo realistic paper, according to the invention herein;

FIG. 2 is a sectional view of another sheet of photorealistic paper according to the invention herein; and

FIG. 3 is a sectional view of another sheet of photorealistic paper according to the invention herein.

The same reference numerals refer to the same elements, as more fully set forth in the following detailed description.

### DESCRIPTION OF PREFERRED EMBODIMENTS

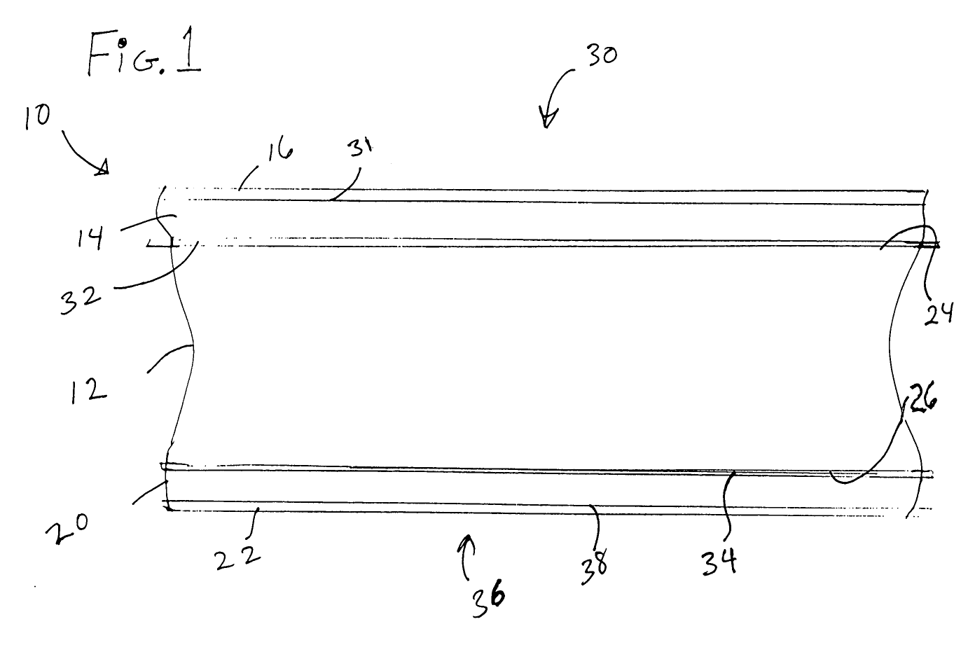

With reference to FIG. 1, a sheet of photo realistic paper 10 generally comprises a paper substrate 12, a print side layer 14 of polyolefin on a print side 30 of the paper substrate 12, and a receptor layer 16 on the layer 14 of polyolefin. The back side 36 of the photo realistic paper 10 generally comprises a back side layer 20 of polyolefin and anti-blocking layer 22 over the polyolefin layer 20.

The paper substrate 12 is a high grade pulp and fiber paper with good formation. In the embodiment shown, it has a weight of about 200 g/m² and thickness of 10 mils, but may be provided in a range of thicknesses from 3 mils to 14 mils, and preferably in a range of thicknesses from 4 mils to 11 mils. Paper substrate having a weight of about 180 g/m² and thickness of about 8 mils is also a desirable example. In the embodiment shown, the paper substrate 12 is clay coated on its upper surface 24, and on its lower surface 26. The paper substrate 12 may be clay coated on the print side only, or may be provided without a clay coating. The clay coat is advantageous for providing a smooth surface 24, and also acts as a heat sink with respect to fuser heat in laser printing.

The upper or print side of the photo realistic paper 10 is generally indicated at 30, i.e. the print side 30 is at the upper side of FIG. 1. The paper substrate 12 is provided with an adhesion promotion layer 32, which may also be referred to as a primer, on upper surface 24. The primer is polyurethane based, and is preferably a polyemylenimine sold by BASF Co. under the trade name Luposol. It will be appreciated that the primer layer 32 is provided to increase the adherence of the polyolefin layer 14 to the paper substrate 12, and that the primer layer 32 may or may not be necessary, depending on the particular process and technique involved in applying the polyethylene layer 14 as well as the particular surface characteristics of the paper substrate 12.

The print side layer 14 of polyolefin is extruded onto the primer layer 32. The layer 14 of polyolefin is low density polyethylene (LDPE) in this example, but may be a blend of LDPE and high density polyethylene (HDPE), in a ratio of from 50-99% low density polyethylene (LDPE) with the remainder HDPE. The low density polyethylene flows more easily and is therefore well adapted to provide either a glossy or semi-glossy surface 31, and has a low glass transition temperature. It is preferred that the polyolefin layer 14 has a glass transition temperature in the range of 5° C. to 30° C., and a range of from −19° C. to 60° C. is suitable, particularly with thicker or thinner paper substrates. The selection is made so that the fuser heat softens the layer 14 to receive toner particles and to melt toner particles in forming a smooth bright image. Other polyolefins are suitable for the layer 14, including polypropylene, and a blend of polyethylene and polypropylene may be used for the layer 14.

The polyethylene layer 14 is also provided with pigment to increase the brightness so that the print side 30 of the photo realistic paper 10 has a bright, white appearance which also contributes to high quality printed image. The pigment is preferably titanium dioxide (TiO₂), provided in a range of 1-20% of the polyethylene of layer 14, with pigment in the range of 7-15% being suitable. Pigments other than titanium dioxide are also suitable. The desired brightness may also be obtained by pigmentation of the clay coating on surface 24 of paper 12, or by combinations of pigmentation of the polyethylene layer 14 and the clay coating.

The polyethylene forming layer 14 is extruded onto the adhesion layer 32 at a rate of approximately 22 g/m², with a most preferred range of 20-25 g/m². A preferred range is 12-30 g/m² and the range of the application rate may extend to approximately 7-35 g/m².

The polyethylene print side layer 14 is provided in a glossy finish surface 31, which may be in the range of 80-85% reflectance at an angle of 75°. A semi-glossy or satin photo finish may also be provided if desired, e.g. with 60-65% reflectance at an angle of 75°.

The receptor layer 16 is provided on the upper surface 32 of the polyethylene front side layer 14. The receptor layer 16 is adapted to accept at least laser printing and preferably both ink-jet printing and printing by laser printer. Suitable materials for the receptor layer 16 are commercially available, and a preferred material for a dual receptor layer, i.e. a receptor layer adapted to accept both ink-jet printing and laser printing, is sold under the trade designation GSP-RD1 by Esprix Chemical of Sarasota, Fla. Esprix Model 6SP-RD2 is also suitable. Other suitable materials for dual receptor layers are sold by Nucoat (the IJ series), Craig Adhesive Products and DCI Corp. of Japan. The receptor layers are typically polyurethane based and may include a transparent pigment, such as aluminum silicate having a particle size of less than 300 nanometers. The receptor layer 16 is applied at a preferred rate of about 8 g/m², with a preferred range of 5-25 g/m² and a usable range of 4-50 g/m². The receptor layer 16 may be applied in two or three coatings to achieve the total application weight set forth above, as in some instances it has been found that the photo realistic paper 10 is less prone to cracking if the receptor layer is provided in two or three coatings. The receptor layer may also be provided in a glossy or semi-glossy finish, as desired.

The back side of the photo realistic paper 10, generally indicated at 32, also has a polyolefin, preferably polyethylene, back layer 20 applied over an adhesion layer 34, which may have the same composition as the adhesion layer 32. The polyethylene back layer 20 includes a substantial portion of high density polyethylene (HDPE), preferably about 100% HDPE. A range of 50-100% HDPE is desirable, with the remainder being a blend of LDPE and HDPE is also suitable. The high density polyethylene layer 20 is extruded onto surface 26 at a rate of approximately 25 g/m², with a preferred range of 22-30 g/m². A range of 10-35 g/m² is suitable. The higher percentage of HDPE is utilized to maintain a glass transition temperature that is higher than the polyolefin layer 14 on the print side of the photorealistic paper 10 so that layer 20 does not soften too much during laser printing in which the fuser heat is applied from the back side of the paper. High density polypropylene may also be used. A matte or semi-matte surface 38 of layer 20 is provided. The layer 20 includes from 0.1-5% additives, such as a colorant, pigment, anti-static additive, and wax additive, the latter for providing a lubricious surface wherein stacks of the photo realistic paper 10 will separate and feed into printers easily.

It is also desirable to add an anti-blocking layer 22 including a surface of polystyrene beads or the equivalent having a particle size in the range of 5-35 microns, with a preferred range of 7-28 microns. This anti-blocking layer 22 permits a stack of photo realistic paper 10 to be easily separated into individual sheets, either for hand separating or mechanical feeding to printers. It also increases the heat absorption capability of the photo realistic paper 10.

The photo realistic paper 10 is suitable for printing by laser printers and for copying. It will be appreciated that laser printing and copying subjects the paper 10 to higher heat than ink-jet printing. The photo realistic paper 10 according to the invention herein is able to tolerate the increased heat because the various layers provide a sufficient heat sink such that the layers do not soften and degrade during the printing process. Despite the thickness of the paper substrate 12, the print side layer 14 softens sufficiently to accept and hold toner particles, which themselves soften and adhere to the print side 30 of the photorealistic paper 10 to provide a sharp image on a smooth surface. When the top layer 14 is provided with a glossy surface, the printed photorealistic paper 10 will also have a glossy appearance.

When the receptor layer 16 is a dual purpose receptor layer adapted for both laser printing and ink-jet printing, the photorealistic paper 10 may be utilized in either type of printer, or in copiers as well, such that the user has complete flexibility in printing and copying from the user's stock of photorealistic paper 10.

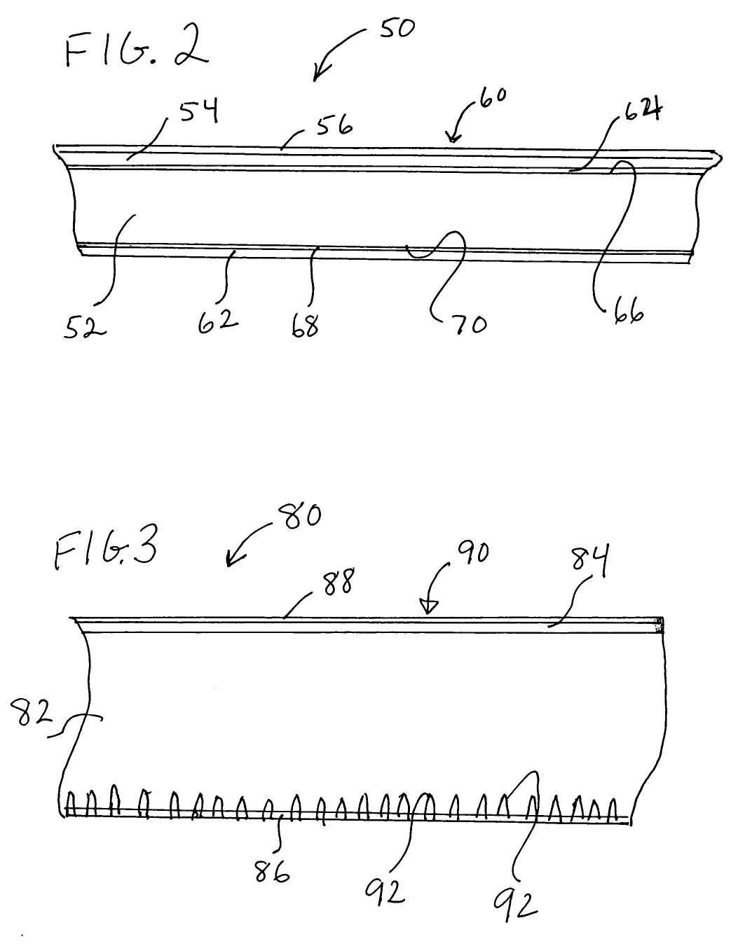

With reference to FIG. 2, another photorealistic paper 50 is shown. It generally comprises a paper substrate 52, a polymer print side layer 54 coated with a receptor layer 56 on the print side 60 of the paper 50, and a polymer back layer 62. The photorealistic paper 50 is characterized by being relatively thin, on the order of 4-7 mils total, so that it can be utilized in printers that cannot accommodate thicker paper, and is further characterized by providing for printing by ink-jet printers and by laser printers and copiers.

The paper substrate 52 of the photorealistic paper 50 is a pulp and fiber paper of about 90-110 g/m² and good formation, having a thickness of approximately 4-5 mils. The paper is not clay coated, and is therefore provided with a primer layer 64 on the top surface 66, and a primer layer 68 on the bottom surface 70.

The polymer layer 54 may be polyethylene, polypropylene or polyester, applied at substantially the same rates disclosed above with respect to photorealistic paper 10. The polymer for the top layer 54 preferably has a glass transition temperature in the range of 5-30° C. A gloss or semi-gloss surface may be provided on the top layer 54, as desired.

The receptor layer 56 is a dual purpose receptor, which provides for printing by either an ink-jet printer or a laser printer, or by copying. The receptor layer may be Esprix Chemicals models GSP-RD1 or GSP-RD2, applied at a rate of 8 g/m², or within the ranges described above with respect to the photorealistic paper 10.

The bottom layer 60 is also a polymer, selected from a group of polyethylene, polypropylene, polyester, ethyl vinyl acetate (EVA), or blends thereof. Higher density polymer is preferred for the back layer 60, such that the back layer 60 has a higher glass transition temperature than the top layer 54.

As noted above, the photorealistic paper 10 provides for printing by either ink-jet or laser, wherein the user has flexibility in printing on the user's stock of photorealistic papers 60.

With reference to FIG. 3, yet another photorealistic paper 80 according to the invention is illustrated. A photorealistic paper 80 also generally comprises a paper substrate 82, a polymer print side layer 84 on print side 90 of photorealistic paper 80, and a polymer back layer 86. The photorealistic paper 70 is at least 8 mils thick, which provides a printed photograph having the heft and feel of a photograph printed by traditional negative-onto-photopaper techniques.

The paper substrate 82 is a pulp and fiber paper with good formation having a weight of approximately 180 g/m² and a thickness of approximately 8 mils. It may or may not be clay coated and may or may not be provided with a primer, but is preferably provided with one or the other to improve the adhesion of the print side polymer layer 84.

The print side layer 84 is a polymer, and may be about 100% polyester if desired. It may also be a blend of polyester and one of the other polymers, such as polyethylene and polypropylene. A receptor layer 88 which is adapted for at least laser printing is coated onto the top layer 74. The bottom layer 84 is also a polymer, and may be up to 100% polyester or may be polyethylene, polypropylene, EVA, or maybe blends of the foregoing. The photorealistic paper 80 preferably has a receptor layer 88 adapted for both ink-jet printing and laser printing or copying to increase the versatility in use.

The application rates and thicknesses of the top layer 84, receptor layer 88 and bottom layer 84 may be as discussed above with respect to the photorealistic paper 10.

The photorealistic paper 80 is characterized by perforations 92 formed through the bottom layer 86 of the paper 80, extending through the bottom layer 86 and into the paper substrate 82. These perforations 92 permit the use of polyester top layer 84 and polyester bottom layer 86, if desired, in a paper 80 exceeding 8 mils in thickness. The paper substrate 82 inherently retains an amount of moisture, and the polyester layer 84 tends to seal that moisture in the paper substrate 82. Thus, if a photorealistic paper such as paper 80 but without perforations 92 is passed through a laser printer or copier, the moisture can vaporize and cause separation or delamination of the paper. The perforations 92 permit moisture vapor to escape from the paper substrate 82 and thereby avoiding such delamination, permitting in a thicker photorealistic paper with a polyester top layer that is suitable for laser printing.

Accordingly, photorealistic papers have been described which admirably achieve the objects of the invention herein. It will be appreciated that the papers described are preferred embodiments illustrating the various objects and features of the invention, and that changes may be made by those skilled in the art without departing from the spirit and scope of the invention which is limited only by the following claims.

I claim:

1. A photorealistic paper comprising:
A) a paper substrate paper having a print side and a back side;
B) a polyolefin print side layer applied to the print side of the paper substrate and having a glass transition temperature in the range of −19° to 60° C.;
C) a receptor layer applied over the polyolefin print side layer, the receptor layer being adapted for laser printing; and
D) a polymer back layer applied to the back side of the paper substrate.

2. A photorealistic paper as defined in claim 1 wherein the paper substrate has a weight of about 180-200 g/m² and a thickness of about 8-10 mils.

3. A photorealistic paper as defined in claim 1 wherein the paper substrate has a weight of about 90-100 g/m² and a thickness of about 4-5 mils.

4. A photorealistic paper as defined in claim 1 wherein the polyolefin print side layer has a glass transition temperature in the range of 5-30° C.

5. A photorealistic paper as defined in claim 1 wherein the polyolefin print side layer is 50-100% low density polyethylene.

6. A photorealistic paper as defined in claim 5 wherein the polyolefin print side layer is 100% low density polyethylene.

7. A photorealistic paper as defined in claim 6 wherein the application rate of the polyolefin print side layer is 12-30 g/m².

8. A photorealistic paper as defined in claim 7 wherein the application rate of the polyolefin print side layer is in the range of 20-25 g/m².

9. A photorealistic paper as defined in claim 1 wherein the receptor layer is adapted for printing by both ink-jet printers and laser printers.

10. A photorealistic paper as defined in claim 9 wherein the paper substrate has a weight of about 180-200 g/m² and a thickness of about 8-10 mils.

11. A photorealistic paper as defined in claim 9 wherein the polyolefin print side layer is 50-100% low density polyethylene.

12. A photorealistic paper as defined in claim 11 wherein the polyolefin print side layer is about 100% low density polyethylene.

13. A photorealistic paper as defined in claim 11 wherein the application rate of the polyolefin print side layer is in the range of 20-25 g/m².

14. A photorealistic paper as defined in claim 9 wherein the paper substrate has a weight of about 90-110 g/m² and a thickness of about 4-5 mils.

15. A photorealistic paper comprising:
A) a paper substrate having a print side and a back side;
B) a polymer print side layer applied to the print side of the paper substrate, the polymer selected from the group including polyethylene, polypropylene, polyester and blends thereof; and
C) a receptor layer applied over the polymer print side layer, the receptor layer adapted to accept printing by ink-jet printers and by laser printers.

16. A photorealistic paper as defined in claim 15 and further comprising a polymer print side layer applied to the back side of the paper substrate.

17. A photorealistic paper comprising:
A) a paper substrate having a weight of at least 180 g/m² and a thickness of at least 7 mils and having a print side and a back side;
B) a polymer print side layer applied to the print side of the paper substrate, the polymer being selected from the group including polyethylene, polypropylene, polyester and blends thereof;
C) a receptor layer applied over the polymer layer, the receptor layer adapted to receive laser printing; and
D) a polymer back side layer applied to the back side of the paper substrate.
Wherein the polymer back side layer is perforated with the perforations extending into the paper substrate, thereby permitting moisture vapor created by the heat of laser printing to exit the paper substrate through the back side layer.

18. A photorealistic paper as defined in claim 17 wherein the receptor layer is adapted to receive printing by ink-jet printers and by laser printers.

19. A photorealistic paper comprising:
A) a paper substrate having a print side and a back side, the paper substrate having a weight of about 180-200 g/m² and a thickness of about 8-10 mils;
B) a polymer print side layer including at least 50-100% low density polyethylene applied to the print side of the paper substrate at a rate of 20-25 g/m², the polymer print side layer further including a brightening pigment comprising about 7-15% of the polymer print side layer by weight, the polyolefin print side layer having a glass transition temperature in the range of 5-30° C.;
C) a receptor layer applied to the polymer print side layer, the receptor layer having a polyurethane base and adapted to receive printing by both ink-jet printers and laser printers; and
D) a polymer back side layer applied to the back side of the paper substrate, the polymer back side layer including high density polyethylene.

20. A photorealistic paper as defined in claim 19 wherein the brightening pigment is titanium dioxide.

21. A photorealistic paper as defined in claim 19 wherein the print side of the paper substrate is coated with a primer prior to application of the polymer print side layer.

22. A photorealistic paper as defined in claim 19 wherein a paper substrate is clay coated on at least the print side thereof.
